(19) United States
(12) Patent Application Publication
(10) Pub. No.: US 2009/0103887 A1
(43) Pub. Date: Apr. 23, 2009

(54) VIDEO TAGGING METHOD AND VIDEO APPARATUS USING THE SAME

(75) Inventors: Seung-Eok CHOI, Suwon-si (KR); Sin-Ae KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/255,239

(22) Filed: Oct. 21, 2008

(30) Foreign Application Priority Data
Oct. 22, 2007 (KR) 10-2007-0106253

(51) Int. Cl. G06K 9/00; H04N 5/93

(52) U.S. Cl. 386/52; 382/118

(57) ABSTRACT

A video tagging method and a video apparatus using the video tagging method are provided. The video apparatus includes a player module which plays a video; a face recognition module which recognizes a face of a character in the video; a tag module which receives a tagging key signal for tagging a scene of the video including the character and maps a tagging key corresponding to the tagging key signal and a number of scenes including the face recognized by the face recognition module; and a storage module which stores the result of mapping performed by the tag module.

### CROSS-REFERENCE TO RELATED APPLICATION

This application claims priority from Korean Patent Application No. 10-2007-0106253 filed on Oct. 22, 2007 in the Korean Intellectual Property Office, the disclosure of which is incorporated herein by reference in its entirety.

### BACKGROUND OF THE INVENTION

1. Field of the Invention

Methods and apparatuses consistent with the present invention relate to a video tagging method and a video apparatus using the video tagging method, and, more particularly, to a video tagging method and a video apparatus using the video tagging method in which moving videos can be easily tagged and searched for on a character-by-character basis.

2. Description of the Related Art

Tags are keywords associated with or designated for content items and describe corresponding content items. Tags are useful for performing keyword-based classification and search operations.

Tags may be arbitrarily determined by individuals such as authors, content creators, consumers, or users and are generally not restricted to certain formats. Tags are widely used in resources such as computer files, web pages, digital videos, or Internet bookmarks.

Tagging has become one of the most important features of Web 2.0 and Semantic Web.

Text-based information or paths that can be readily accessed at any desired moment of time may be used as tag information in various computing environments. However, unlike computers, existing video apparatuses such as television (TV) sets, which handle moving video data, are not equipped with an input device via which users can deliver their intentions. In addition, input devices, if any, of existing video apparatuses are insufficient to receive information directly from users, and have no specific mental models. Moreover, operating environments, or functions that enable users to input information to existing video apparatuses have been suggested. Therefore, it is almost impossible for users to input tag information to existing video apparatuses. Therefore, even though it is relatively easy to obtain various content such as Internet protocol (IP) TV programs, digital video disc (DVD) content, downloaded moving video data, and user created content (UCC), it is difficult to search for desired content.

### SUMMARY OF THE INVENTION

The present invention provides a video tagging method and a video apparatus using the video tagging method in which moving videos can be easily tagged and searched for on a character by character basis.

The present invention also provides a video tagging method and a video apparatus using the video tagging method in which tagged moving videos can be conveniently searched for on a character by character basis.

However, the objectives of the present invention are not restricted to the ones set forth herein. The above and other objectives of the present invention will become apparent to one of ordinary skill in the art to which the present invention pertains by referencing a detailed description of the present invention given below.

According to an aspect of the present invention, there is provided a video apparatus including a player module which plays a video; a face recognition module which recognizes a face of a character in the video; a tag module which receives a tagging key signal for tagging a scene of the video including the character and maps a tagging key corresponding to the tagging key signal and a number of scenes including the face recognized by the face recognition module; and a storage module which stores the result of mapping performed by the tag module.

According to another aspect of the present invention, there is provided a video tagging method including reproducing a video and recognizing a face of a character in the video; receiving a tagging key signal for tagging a scene of the video including the character and mapping a tagging key corresponding to the tagging key signal and a number of scenes including the face recognized by the face recognition module; and storing the result of the mapping.

### BRIEF DESCRIPTION OF THE DRAWINGS

The above and other features of the present invention will become apparent by describing in detail exemplary embodiments thereof with reference to the attached drawings in which:

FIG. 1 illustrates a block diagram of a video apparatus according to an embodiment of the present invention;

FIG. 2 illustrates the mapping of characters in a moving video and color keys;

FIG. 3 illustrates search results obtained by performing a search operation on a character by character basis;

FIGS. 4A and 4B illustrate the summarization of moving videos on a character by character basis;

FIG. 5 illustrates a flowchart of a video tagging method according to an embodiment of the present invention; and

FIG. 6 illustrates a flowchart of the search of a video as performed in the video tagging method illustrated in FIG. 5.

### DETAILED DESCRIPTION OF THE EXEMPLARY EMBODIMENTS

The present invention will now be described more fully with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art. Like reference numerals in the drawings denote like elements, and thus their description will be omitted.

The present invention is described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer readable memory that can direct a computer or other programmable data processing apparatus to function in a particular manner, such that the instructions stored in the computer usable or computer readable memory produce an article of manufacture including instruction means that implement the function specified in the flowchart block or blocks.

The computer program instructions may also be loaded into a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

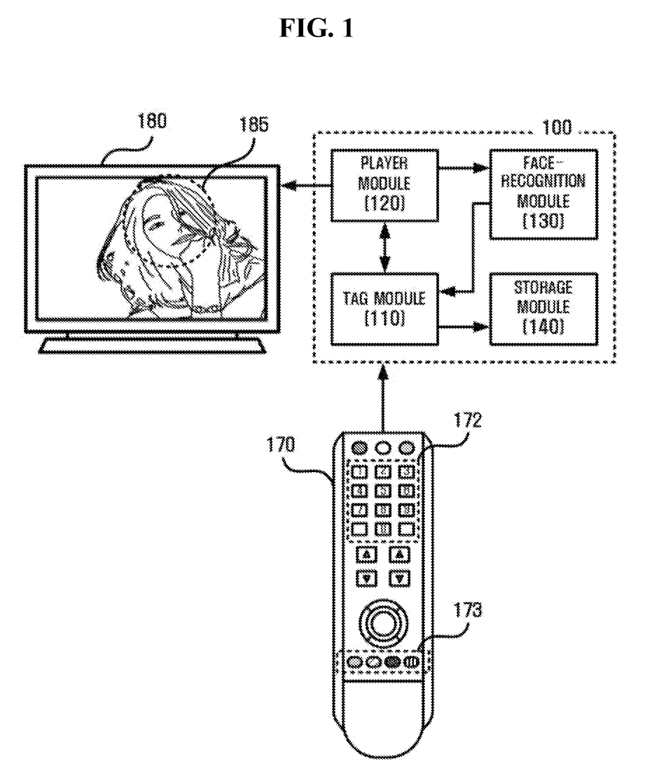

FIG. 1 illustrates a block diagram of a video apparatus 100 according to an embodiment of the present invention. Referring to FIG. 1, the video apparatus 100 includes a player module 120, a face recognition module 130, a tag module 110 and a storage module 140. In an exemplary embodiment, the video apparatus 100 may be a video player apparatus.

The video apparatus 100 may be a set top box of a digital television (TV) set or an Internet protocol TV (IPTV) set, may be a video player such as a digital video disc (DVD) player, or may be a portable device such as a mobile phone, a portable multimedia player (PMP), or a personal digital assistant (PDA).

The player module 120 receives a video signal. Then, the player module 120 may convert and play the received video signal so that the received video signal can be displayed by a display device 180. Alternatively, the player module 120 may convert and play a video file previously stored in the video apparatus 100. The type of video signal received by the player module 120 may vary according to the type of video apparatus 100.

The face recognition module 130 recognizes a face 185 of a character in a moving video currently being played by the player module 120. The face recognition module 130 may recognize the face 185 using an existing face detection/recognition algorithm.

The tag module 110 receives a tagging key signal from an input device 170. Then, the tag module 110 maps a tagging key corresponding to the received tagging key signal to the face 185.

When a desired character appears on the screen of the display device 180, a user may input a tagging key. The input device 170 may be a remote control that controls the video apparatus 100.

The input device 170 may provide a regular mode, a tagging mode and a search mode. The input device 170 may include one or more buttons or provide one or more software menu items for providing each of the regular mode, the tagging mode and the search mode. In the tagging mode, number buttons or color buttons of a remote control may be used as tagging buttons. In the search mode, the number buttons or the color buttons may be used as query buttons for a search operation. Alternatively, the input device 170 may provide none of the tagging mode and the search mode. In this case, a tagging operation may be performed in any circumstances by using color buttons of a remote control, and then a search operation may be performed using a search button or a search menu.

Number keys 172 or color keys 173 of the input device 170 may be used as tagging keys. If the number of characters in a moving video is four or less, tagging may be performed using the color keys 173. In contrast, if the number of characters in a moving video is more than four, tagging may be performed using the number keys 172. The color keys 172 may include red, yellow, blue, and green keys of a remote control.

When a desired character appears in a moving video, the user may generate a tagging key signal by pressing one of the color keys 172 of the input device 170. Then, the tag module 110 receives the tagging key signal generated by the user. Alternatively, the user may generate a tagging key signal by pressing one of the number keys 172.

One of the color keys 172 pressed by the user may be mapped to the face 185, which is recognized by the face recognition module 130. Alternatively, one of the number keys 172 pressed by the user may be mapped to the face 185.

If the user inputs different tagging keys for the same character or inputs the same tagging key for different characters, the tag module 110 may notify the user that the user has input a redundant tagging key, and then induce the user to input a proper tagging key.

Even when no tagging key is input by the user, the tag module 110 may perform automatic tagging if a character recognized by the face recognition module 130 already has a tagging key mapped thereto. The precision of data obtained by automatic tagging may be low at an early stage of automatic tagging. However, the performance of automatic tagging and the precision of data obtained by automatic tagging may increase over time. Once automatic tagging is performed, the result of automatic tagging may be applied to a series of programs. A plurality of tagging keys may be allocated to one character if there is more than one program in which the character features.

In automatic tagging, only videos including characters are used. Even a video including a character may not be used in automatic tagging if the face of the character is hard to be recognized by the face recognition module 130. Therefore, the user may not necessarily have to press a tagging key whenever a character appears. Instead, the user may press a tagging key whenever the hairstyle or outfit of a character considerably changes.

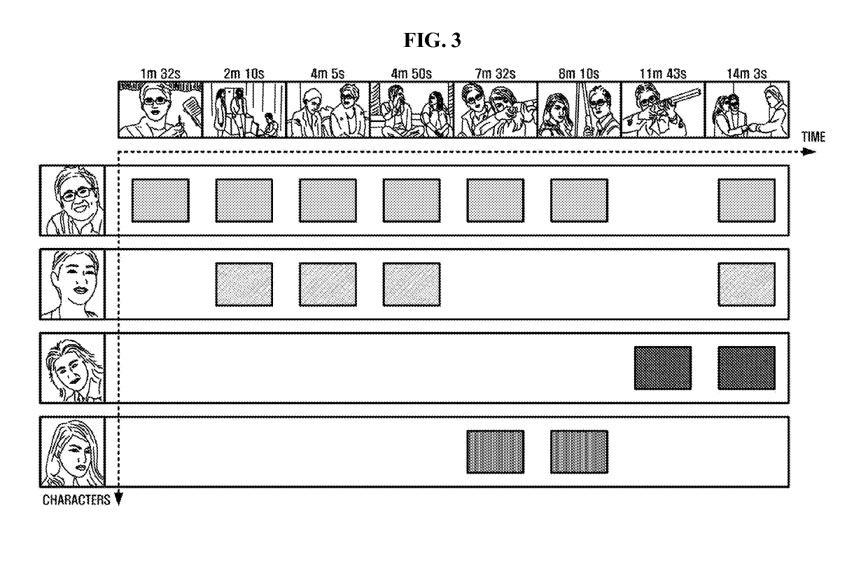

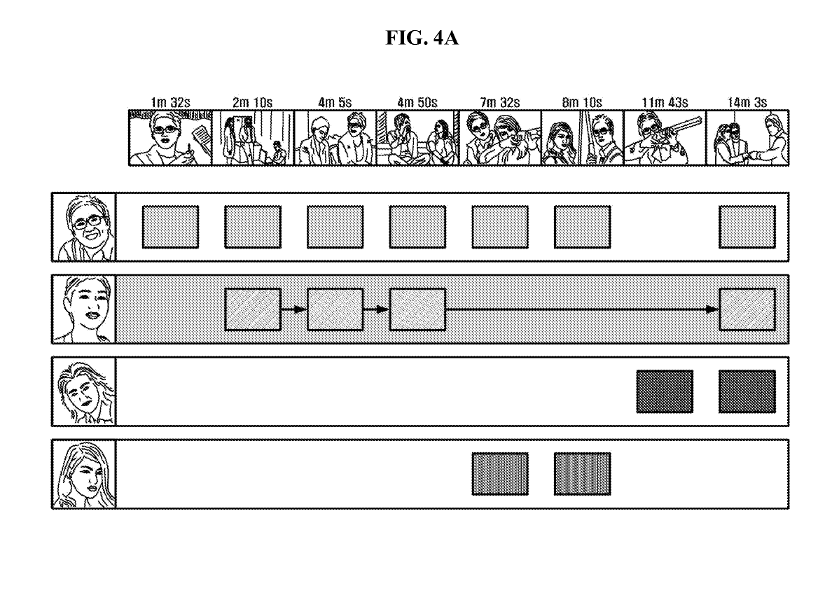

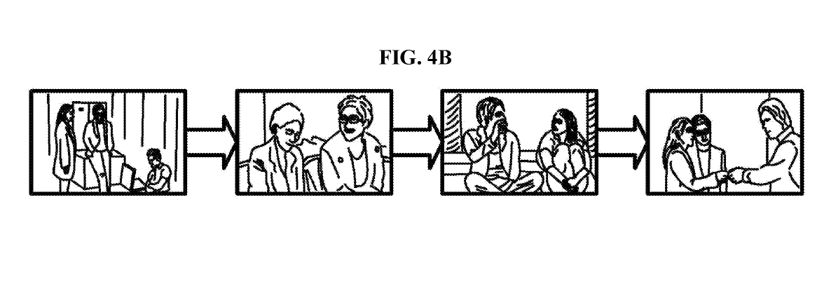

If the user wishes to search for a video including a character tagged with a predetermined tagging key, the tag module 110 may perform a search operation and display search results obtained by the search operation. This will be described later in further detail with reference to FIGS. 3 and 4.

The storage module 140 stores the results (hereinafter referred to as the mapping results) of mapping tagging keys and videos having characters whose faces have been recognized. The storage module 140 may store the mapping results in the video apparatus 100 or in a remote server. The storage module 140 may store a tagging key input by the user, the time of input of the tagging key, program information and a number of scenes that are captured upon the input of the tagging key as the mapping results.

If the user wishes to search for a video including a character tagged with a predetermined tagging key, the storage module 140 may search the mapping results present therein for the video including the character tagged with the predetermined tagging key and then transmit the detected video to the tag module 110. The storage module 140 may be configured as a typical data database (DB) system so that the storage and search of videos can be facilitated.

If the storage module 140 stores the mapping results in a remote server, the storage module 140 may be used to provide interactive TV services or customized services. It is possible to determine programs, actors or actresses, a time zone of the day, a day of the week, and genres preferred by a user by analyzing keys of a remote control input by the user. Thus, it is possible to provide customized content or services for each individual.

The video apparatus 100 and the display device 180 may be incorporated into a single hardware device. Alternatively, the video apparatus 100 and the input device 170 may be incorporated into a single hardware device.

The term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

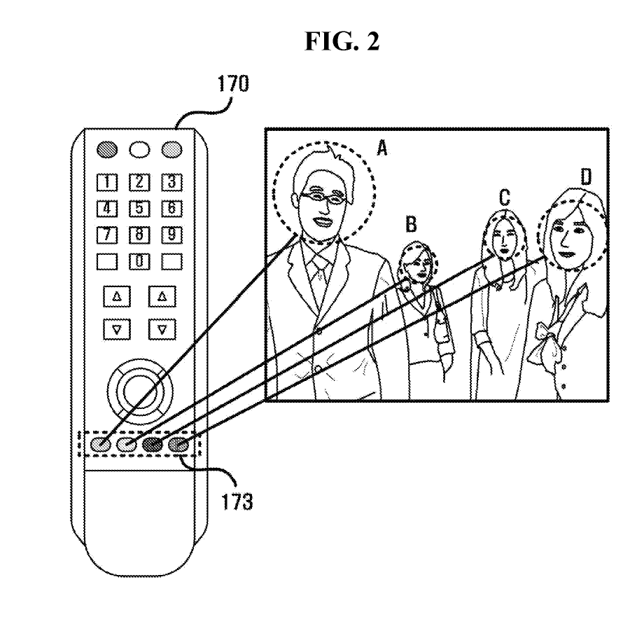

FIG. 2 illustrates the mapping of characters in a moving video and the color keys 173. Referring to FIG. 2, a user may input one of the color keys 172 or one of the number keys 172 of the input device 170 when a desired character appears in a broadcast program or a moving video. If the video apparatus 100 supports a tagging mode, the user may input one of the number keys 172 of the input device 170. The input of a tagging key may be interpreted as allocating a button value or a key value to a character.

Referring to FIG. 2, assuming that there is a broadcast program featuring actor A and actresses B, C and D, the user may input a red key whenever a scene including actor A is encountered, input a green key whenever a scene including actress B is encountered, input a blue key whenever a scene including actress C is encountered, and input a yellow key whenever a scene including actress D is encountered. The user may input none of the red, green, blue and yellow keys or input more than one of the red, green, blue and yellow keys for scenes including more than one of actor A and actresses B, C and D.

As described above, when a character appears in a moving video or a broadcast program, the user inputs a tagging key. Then, the video apparatus 100 may store the character and the tagging key input for the character in a database DB. The video apparatus 100 may use a video provided thereto upon the input of a tagging key by a user as input data and apply a face recognition technique to the input data. This operation may be performed for more than a predefined period of time or may be performed more than a predefined number of times, thereby increasing the performance of face recognition and the precision of data obtained by face recognition. The video apparatus 100 may store a tagging key input by a user and result values obtained by face recognition in a DB along with broadcast program information.

The user may input a tagging key only for his/her favorite actors/actresses or broadcast programs. The user may also input a tagging key for each broadcast program. Therefore, if there is more than one broadcast program in which actor A features, the user may allocate the same tagging key or different tagging keys for actor A.

Referring to FIG. 2, when a broadcast program includes more than one main character, different color keys may be allocated to the main characters. If a broadcast program includes more than one main character or there is more than one character for which the user wishes to perform a tagging operation, an additional tagging mode may be provided, and thus, the user may be allowed to use the number buttons 172 as well as the color keys 172 as tagging keys.

A scene captured upon the input of a tagging key by the user may be ignored if the scene includes no character. In the case of a series of broadcast programs having the same cast, a plurality of characters that feature in the series of broadcast programs may be mapped to corresponding color keys 172 in advance.

FIG. 3 illustrates search results obtained by performing a search operation on a character by character basis. Referring to FIG. 3, a user may perform a search operation using tagging results obtained by a manual or automatic tagging operation performed by the user or a system. Search results obtained by the search operation only include scenes having a character mapped to a tagging key.

When the user issues a search command by inputting a search key, characters that are mapped to corresponding tagging keys and scenes including the characters are displayed on the screen of the input device 180, as illustrated in FIG. 3. Then, the user may select one or more of the scenes and play the selected scenes.

The manner in which search results are displayed on the screen of the input device 180 may vary according to the type of the type of GUI. A GUI that displays the search results on the screen of the display unit 180 as thumbnail videos may be used. The search results may not necessarily be displayed together on the screen of the display unit 180.

A search operation may be performed on a video source by video source basis. In this case, a plurality of video sources corresponding to a desired character may be searched for and then displayed on the screen of the display unit 180 upon input of a tagging key

FIGS. 4A and 4B illustrate the summarization of videos on a character by character basis. Referring to FIGS. 4A and 4B, a desired character or a desired video may be searched for by performing a search operation, and search results obtained by the search operation may be summarized. A video summarization function may be made available on a screen where the search results are displayed. Alternatively, a video summarization operation may be performed along with a search operation so that a video obtained as a result of the search operation can be readily summarized. A video may be summarized using a filter that selects only a number of scenes including a character mapped to a tagging key by the user. In this manner, it is possible to reflect the user's intentions and preferences.

The user may select a character from search results illustrated in FIG. 4A by inputting a tagging key. Then, a video summarization operation may be performed by sequentially reproducing a number of scenes including the selected character, as illustrated in FIG. 4B.

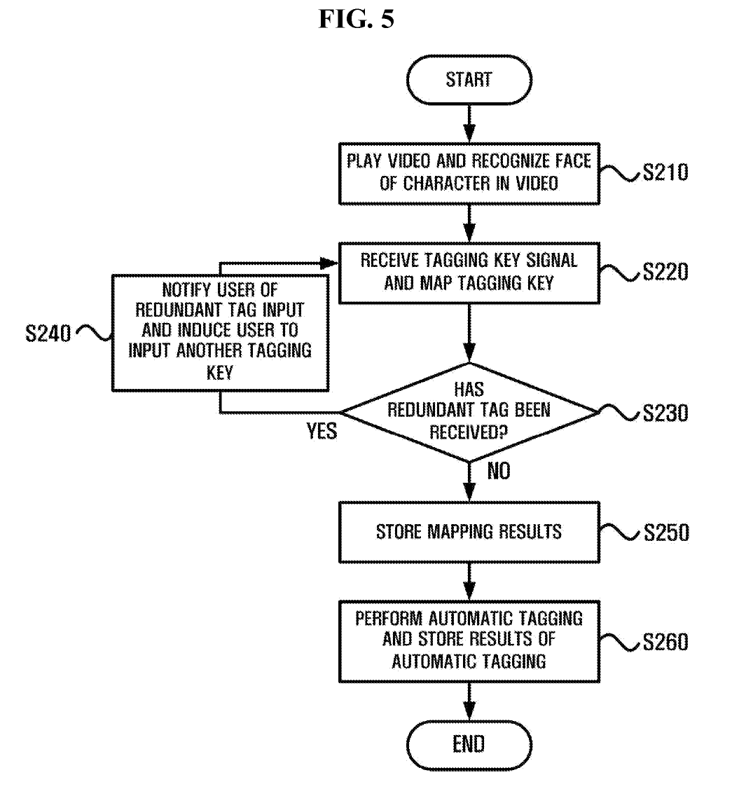

FIG. 5 illustrates a flowchart of a video tagging method according to an embodiment of the present invention. Referring to FIG. 5, the face of a character in a moving video is recognized during playback of the moving video (S210). If the video apparatus 100 is a set top box of a digital TV set or an IPTV set, the player module 120 of the video apparatus 100 receives a video signal and converts and plays the received video signal so that the received video signal can be displayed by the display device 180. In contrast, if the video apparatus 100 is a video player such as a DVD player or a portable device such as a mobile phone, a PMP or a PDA, the player module 120 of the video apparatus 100 may convert and play a video file previously stored in the video apparatus 100.

During playback of a moving video, the face recognition module 130 recognizes a face 185 of a character in the moving video. The face recognition module 130 may recognize the face 185 using an existing face detection/recognition algorithm.

If a user inputs a tagging key for a desired character, the video apparatus 100 maps the input tagging key and a video including the desired character (S220). Specifically, the user may press one of the color keys 173 of the input device 170 when the desired character appears in a moving video. Then, the tag module 110 receives a tagging key signal corresponding to the color key 173 pressed by the user. Alternatively, the tag module 110 may receive a tagging key signal corresponding to one of the number keys 172 pressed by the user.

Once a tagging key signal is received, the tag module 110 maps a tagging key corresponding to the received tagging key signal and a video including the face 185, which is recognized by the face recognition module 130.

Thereafter, it is determined whether the received tagging key signal is redundant (S230). Specifically, the tag module 110 determines whether the user has input different tagging keys for the same character or has input the same tagging key for different characters based on a character having the face 185 and a mapping value previously stored for the character having the face 185.

If it is determined that the received tagging key signal is redundant, the user may be notified that the received tagging key signal is redundant, and may be induced to input another tagging key (S240). Specifically, if the user has input different tagging keys for the same character or has input the same tagging key for different characters, the tag module 110 may notify the user that the user has input a redundant tagging key, and then induce the user to input a proper tagging key.

In contrast, if it is determined that the received tagging key signal is not redundant, the storage module 140 stores the results (hereinafter referred to as the mapping results) of mapping performed in operation S220 (S250). Specifically, the storage module 140 may store the mapping results in the video apparatus 100 or in a remote server. The storage module 140 may store a tagging key input by the user, the time of input of the tagging key, program information and a number of scenes that are captured upon the input of the tagging key as the mapping results.

Thereafter, automatic tagging is performed on a character by character basis (S260). Even when no tagging key is input by the user, the tag module 110 may perform automatic tagging if a character recognized by the face recognition module 130 already has a tagging key mapped thereto. The precision of data obtained by automatic tagging may be low at an early stage of automatic tagging. However, the performance of automatic tagging and the precision of data obtained by automatic tagging may increase over time. Once automatic tagging is performed, the result of automatic tagging may be applied to a series of programs. A tagging key mapped to a character may vary from one program to another program in which the character features.

In automatic tagging, only videos including characters are used. Even a video including a character may not be used in automatic tagging if the face of the character is hard to be recognized by the face recognition module 130. Therefore, the user may not necessarily have to press a tagging key whenever a character appears. Rather, the user may press a tagging key whenever the hairstyle or the outfit of a character considerably changes.

The storage module 140 may also store the results of automatic tagging performed in operation S260.

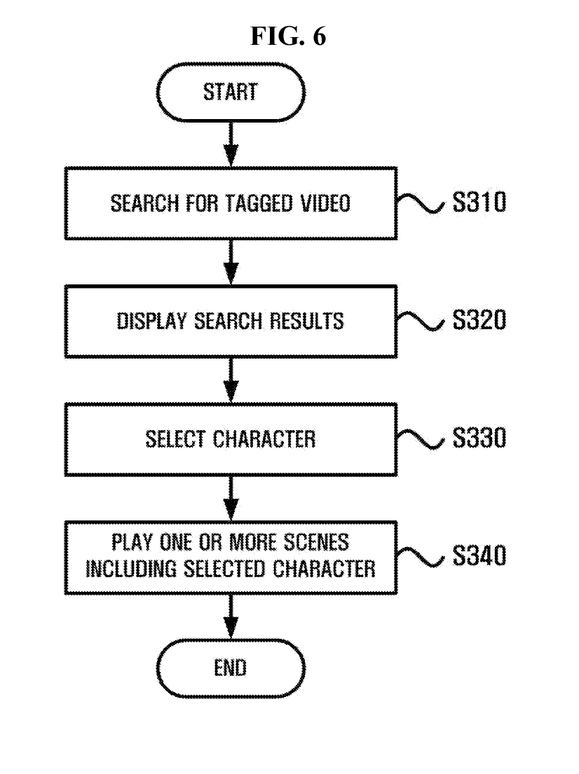

FIG. 6 illustrates the search of a video as performed in the video tagging method illustrated in FIG. 5. Referring to FIG. 6, a video including a character tagged with a predetermined tagging key is searched for (S310). Specifically, when a user issues a search command by inputting a search key, the storage module 140 performs a search operation by searching through the mapping results present therein and transmits the search results to the tag module 110.

The search results are displayed on the screen of the display unit 180 (S320). Specifically, the tag module 110 displays the search results on the screen of the display unit 180. The manner in which the search results are displayed on the screen of the display unit 180 may vary according to the type of GUI. The search results may be displayed on the screen of the display unit 180 as thumbnail videos. The search results may not necessarily be displayed together on the screen of the display unit 180. A search operation may be performed on a video source by video source basis. In this case, a plurality of video sources corresponding to a desired character may be searched for and then displayed on the screen of the display unit 180 upon the input of a tagging key.

The user selects a character by inputting a tagging key (S330). Then, the tag module 110 sends a request for video information or captured videos regarding the selected character to the storage module 140.

Thereafter, the player module 120 receives one or more scenes including the selected character from the storage module 140 and plays the received scenes (S340). In this manner, a video summarization operation may be performed by reproducing only the scenes including the selected character.

As described above, the present invention provides the following aspects.

First, it is possible to perform a tagging operation and a search operation even on a considerable amount of content according to user preferences and intentions. Thus, it is possible to implement new search methods that can be used in various products.

Second, it is possible for a content provider to collect data regarding user preferences and tastes through interactive services such as IPTV services. Therefore, it is possible to provide users with customized content or services. That is, information regarding content and data regarding user preferences may be obtained from the analysis of user input made during the consumption of content, thereby enabling customized services for users. Information regarding content may include the name, the genre, the air time of a broadcast program and characters that feature in the broadcast program. Thus, it is possible to provide users with customized recommendation services or content.

Third, it is possible for a content provider to generate and provide a summary of video data and thus to enable viewers to easily identify the content of the video data. This type of video summarization function is easy to implement and incurs no additional cost.

Fourth, it is possible for a user to easily identify characters in video data and the content of the video data by being provided with a summary of the video data for each of the characters.

Fifth, it is possible to realize a tagging operation that can precisely reflect user intentions in a manner that can be achieved with personal computers. The present invention can be applied to various audio/video (A/V) products and can provide web-based services.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A video apparatus comprising:
a player module which plays a video;
a face recognition module which recognizes a face of a character in the video;
a tag module which receives a signal for tagging a scene of the video including the character and maps, in a mapping, a tagging key corresponding to the signal and a number of scenes including the face recognized by the face recognition module, to generate a mapping; and
a storage module which stores the mapping by the tag module.

2. The video apparatus of claim 1, wherein the tagging key is one of a plurality of color keys of an input device.

3. The video apparatus of claim 1, wherein the tagging key is one of a plurality of number keys of an input device.

4. The video apparatus of claim 2, wherein the color keys comprise a red key, a yellow key, a blue key, and a green key.

5. The video apparatus of claim 1, wherein the tag module automatically tags a scene including the face recognized by the face recognition module based on the mapping stored in the storage module.

6. The video apparatus of claim 1, wherein the tag module performs a search operation by searching through the mapping stored in the storage module and displays search results obtained by the search operation.

7. The video apparatus of claim 6, wherein the tag module displays the number of scenes including the character tagged with the tagging key, as thumbnail videos.

8. The video apparatus of claim 6, wherein the tag module sequentially plays only a number of scenes including the character tagged with the tagging key, if the tagging key is input when the search results are displayed.

9. The video apparatus of claim 6, wherein the tag module performs the search operation on a character by character basis upon an input of the tagging key.

10. The video apparatus of claim 1, wherein the storage module stores at least one of the tagging key, a time of input of the tagging key, program information regarding the video, and a number of scenes including the character tagged with the tagging key.

11. The video apparatus of claim 1, wherein the mapping stored in the storage module is used by a provider of the video for providing customized services.

12. The video apparatus of claim 1, wherein the tag module determines whether the tagging key has been redundantly input.

13. A video tagging method comprising:
reproducing a video and recognizing a face of a character in the video;
receiving a signal for tagging a scene of the video including the character and mapping a tagging key corresponding to the signal and a number of scenes including the face recognized by the face recognition module, to generate a result; and
storing the result.

14. The video tagging method of claim 13, further comprising automatically tagging a scene including the face recognized by the face recognition module based on the result.

15. The video tagging method of claim 13, further comprising determining whether the tagging key has been redundantly input

16. The video tagging method of claim 13, wherein the tagging key is one of a plurality of color keys of an input device.

17. The video tagging method of claim 13, wherein the tagging key is one of a plurality of number keys of an input device.

18. The video tagging method of claim 16, wherein the color keys comprise a red key, a yellow key, a blue key, and a green key.

19. The video tagging method of claim 13, wherein the storing of the result comprises storing at least one of the tagging key, a time of input of the tagging key, program information regarding the video, and the number of scenes including the character tagged with the tagging key.

20. The video tagging method of claim 13, further comprising performing a search operation by searching through the result and displaying search results obtained by the search operation.

21. The video tagging method of claim 20, wherein the displaying of the search results comprises displaying the number of scenes including the character tagged with the tagging key as thumbnail videos.

22. The video tagging method of claim 20, wherein the performing of the search operation comprises performing the search operation on a character by character basis upon the input of the tagging key.

23. The video tagging method of claim 20, further comprising sequentially reproducing only a number of scenes including a character tagged with the tagging key, if the tagging key is input when the search results are displayed.
